(19) United States
(12) Patent Application Publication
(10) Pub. No.: US 2026/0105174 A1
(43) Pub. Date: Apr. 16, 2026

(54) Multiple Custody Authorization

(71) Applicant: Dell Products L.P., Round Rock, TX (US)

(72) Inventors: Shiv S. Kumar, Pune (IN); Kaushik Gupta, Pune (IN); Brian H. Koropoff, Bellevue, WA (US)

(21) Appl. No.: 18/917,965

(22) Filed: Oct. 16, 2024

(51) Int. Cl. G06F 21/62

(52) U.S. Cl. CPC G06F 21/6218

(57) ABSTRACT

A system can mark a file in a computer file storage system as a sensitive file, and determine that an attempt to access the file has been made via a first user account. The system can, based on the attempt to access the file, and on determining that the file is the sensitive file, notify at least one device, associated with a security group, of the attempt to access, wherein the security group comprises at least one user account other than the first user account. The system can, after the notifying, receive access approval data that is associated with at least one of the at least one user account of the security group, wherein the access approval data is indicative of granting the first user account access to the file. The system can, based on receiving the access approval data, enable access to the file via the first user account.

### BACKGROUND

A computer system can store files. Accessing these files can be restricted to user accounts that possess appropriate access rights.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can mark a file in a computer file storage system as a sensitive file. The system can determine that an attempt to access the file has been made via a first user account. The system can, based on the attempt to access the file, and based on determining that the file is the sensitive file, notify at least one device, associated with a security group, of the attempt to access, wherein the security group comprises at least one user account other than the first user account. The system can, after the notifying, receive access approval data that is associated with at least one of the at least one user account of the security group, wherein the access approval data is indicative of granting the first user account access to the file. The system can, based on receiving the access approval data, enable access to the file via the first user account.

An example method can comprise determining, by a system comprising at least one processor, that a user account has made an attempt to access a file. The method can further comprise, based on the attempt to access the file, and based on determining that the file is a sensitive file, notifying, by the system, a security group of the attempt to access. The method can further comprise, after the notifying, receiving, by the system, access approval data that is associated with at least one user account of the security group, wherein the at least one user account excludes the user account, and wherein the access approval data is indicative of granting, to the user account, permission to access the file. The method can further comprise, based on receiving the access approval data, facilitating, by the system, access to the file by the user account.

An example non-transitory computer-readable medium can comprise instructions that, in response to execution, cause a system comprising a processor to perform operations. These operations can comprise, based on an attempt to access a file that is associated with a user account, and based on determining that the file is sensitive according to a sensitivity criterion, notifying at least one device, corresponding to a security group, of the attempt to access. These operations can further comprise, after the notifying, receiving access approval data that is associated with at least one user account of the security group, wherein the access approval data is indicative of granting, to the user account, permission to access to the file. These operations can further comprise, based on receiving the access approval data, permitting access to the file via the user account.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate multiple custody authorization, in accordance with an embodiment of this disclosure;

FIG. 2 illustrates part of an example of a first file access attempt, and that can facilitate multiple custody authorization, in accordance with an embodiment of this disclosure;

FIG. 3 illustrates another part of the example of the first file access attempt, and that can facilitate multiple custody authorization, in accordance with an embodiment of this disclosure;

FIG. 4 illustrates another part of the example of the first file access attempt, and that can facilitate multiple custody authorization, in accordance with an embodiment of this disclosure;

FIG. 5 illustrates part of an example of a second file access attempt, and that can facilitate multiple custody authorization, in accordance with an embodiment of this disclosure;

FIG. 6 illustrates another part of the example of the second file access attempt, and that can facilitate multiple custody authorization, in accordance with an embodiment of this disclosure;

FIG. 7 illustrates another part of the example of the second file access attempt, and that can facilitate multiple custody authorization, in accordance with an embodiment of this disclosure;

FIG. 8 illustrates an example process flow that can facilitate multiple custody authorization, in accordance with an embodiment of this disclosure;

FIG. 9 illustrates another example process flow that can facilitate multiple custody authorization, in accordance with an embodiment of this disclosure;

FIG. 10 illustrates another example process flow that can facilitate multiple custody authorization, in accordance with an embodiment of this disclosure; and

FIG. 11 illustrates an example block diagram of a computer operable to execute an embodiment of this disclosure.

### DETAILED DESCRIPTION

### Overview

With regard to security of computer data, some files can be highly confidential, and it can be determined to provide these files with higher security than other files.

File access can be assigned to a legitimate user. But malicious users can compromise a legitimate user's credential to breach security of storage devices.

It can be that there is not a multi-factored authentication process for a file access. Rather, access can be determined based on an access credential for a given user, and if the user's credentials are compromised, it can be that an intruder can access a highly confidential file.

For instance, there can be a document containing the name of all undercover field agents for an agency in a particular region. If accessing that document can be performed based on a single user's access, the user could be compromised and the data can be accessed and leaked. However, if the same file needs access of three people, improper access of the file can be mitigated against.

In prior approaches, where the person who leaked the data is identified, the data breach has still occurred.

In some examples, the present techniques can be implemented to address this problem with prior approaches to data access. Files that are to be subject to multi-factor authentication (MFA; e.g., highly-sensitive files) can be marked differently from other files, to indicate that they cannot be accessed with only credential authorization. A security group can be created, where the security group's consent is required to access the files. To access one of these files, a user account can first obtain approval from the security group.

Marking sensitive files can be implemented as follows. An interface (e.g., a representational state transfer (REST) application programming interface (API)) can be implemented to facilitate system administrators indicating to a system which files are sensitive. Where the interface is used to mark a file as sensitive, the system can create two extended attributes (which, in some examples, can generally comprise file metadata). One of these extended attributes can comprise “sensitive,” which can be a flag that indicates whether the file is marked sensitive (e.g., TRUE) or not (e.g., FALSE). Where a file lacks a “sensitive” extended attribute, it can be considered to be a normal file (that is, one not subject to the enhanced access process described herein).

Another of these extended attributes can comprise “allowed_users,” which can indicate users that are allowed to access the file (where access is granted via a security group), when the file is marked as sensitive.

A security group can be implemented as follows. A group of system users can be created where those users are able to provide access consent for a sensitive file. There can be a user interface where a user can express interest in accessing a sensitive file. The members of the security group can receive notification of the user request.

Where one or more security group members (in some examples, there can be a minimum number or percentage of members) provides their consent for the user (of the user request) to access the file, that user's id can be added to the file's “allowed_users” extended attribute.

In some examples, this access is valid for a finite and specified amount of time. Where the period of access ends, the user id can be removed from the file's “allowed_users” extended attribute.

It can be that a user interface is utilized to request this file access permission because, under a protocol used to access the file (e.g., server message block (SMB) or network file system (NFS) protocols), the protocol omits functionality to redirect the request to a security group for security group approval and/or the request would generally time out before security group approval is granted.

### Example Architectures, etc.

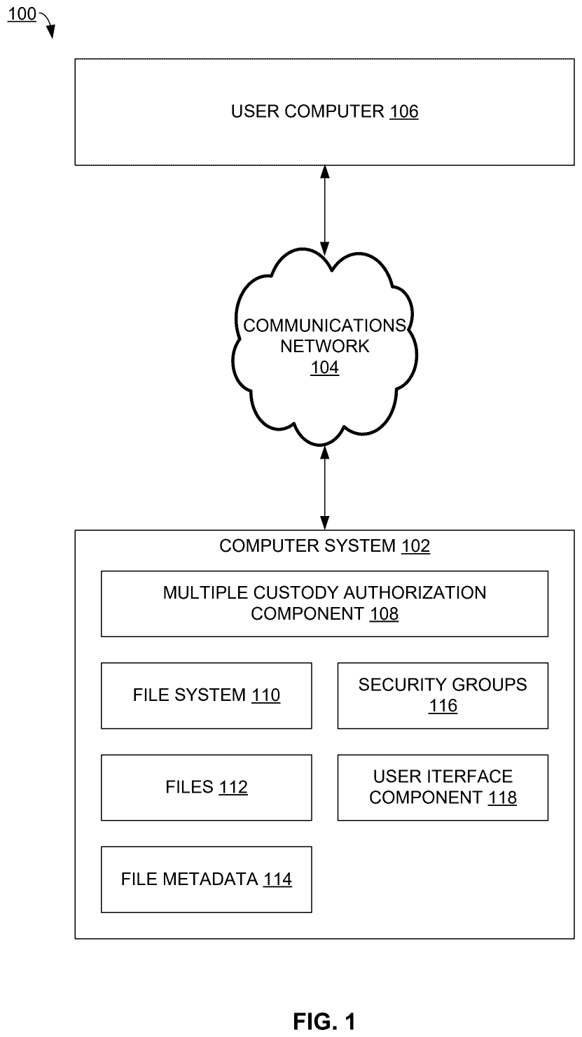

FIG. 1 illustrates an example system architecture 100 that can facilitate multiple custody authorization, in accordance with an embodiment of this disclosure.

System architecture 100 comprises computer system 102, communications network 104, and user computer 106. In turn, computer system 102 comprises multiple custody authorization component 108, file system 110, files 112, file metadata 114, security groups 116, and user interface component 118.

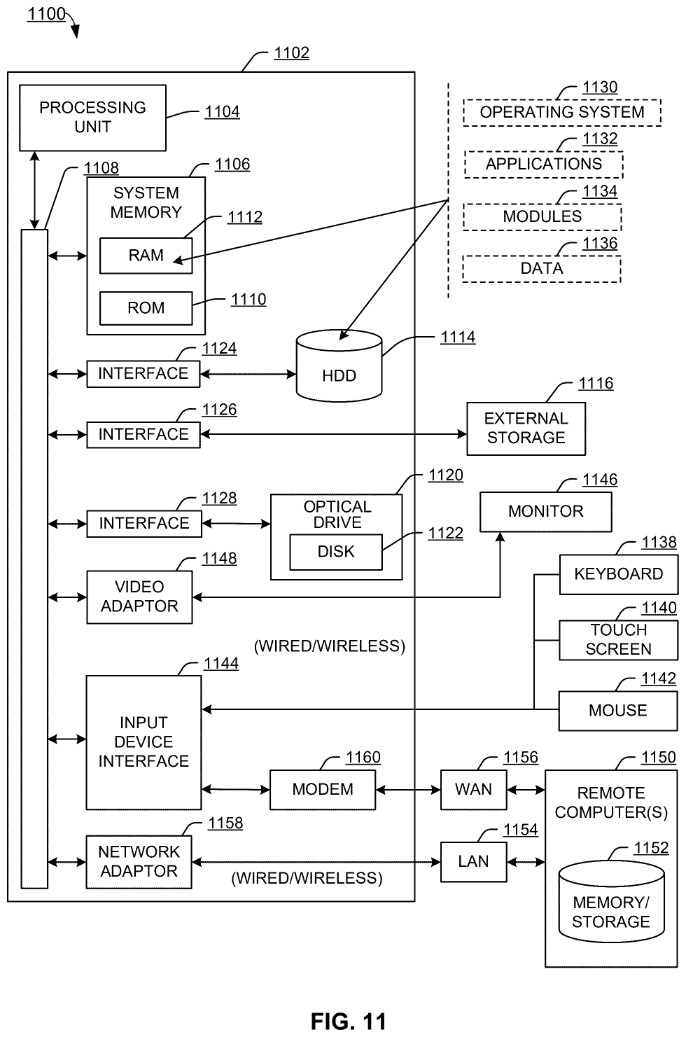

Each of computer system 102 and/or user computer 106 can be implemented with part(s) of computing environment 1100 of FIG. 11. Communications network 104 can comprise a computer communications network, such as the Internet, or an isolated private computer communications network.

User computer 106 can access a user interface generated by user interface component 118 via communications network 104. Through this user interface, user computer 106 can request access to a file of files 112. This request can be forwarded to a corresponding security group of security groups 116, and this security group can comprise one or more user accounts (e.g., admin accounts). Where the security group approves access of the file by user computer 106 (or a user account associated with user computer 106), an indication of this approval can be sent to user computer 106.

Additionally, as a result of this approval, changes can be made to metadata (of file metadata 114) of the file. In an example, this change can be to add an indication of the user account approved for the access to the metadata. The file metadata can also include an indication that accessing the file requires this type of approval from a security group.

When user computer 106 then accesses the file, two checks can be made. A first check can be the standard permissions to access a file (e.g. does the user have read/write/execute (RWX) permissions established for the file in a UNIX file system), and a second check can be the file metadata that (A) this file is subject to security group approval and (B) that the user account associated with user computer 106 is approved to access this file. In this manner, the two checks can be considered to comprise multi factor authentication.

In some examples, there can be more than two checks. For example, for a sensitive file, the user can first login to a computer system that stores a file. Then, when attempting to access a particular file, an access permissions check can be performed, similar to a scenario where the file is not sensitive. Additionally, an access check based on security group approval can be made for a sensitive file.

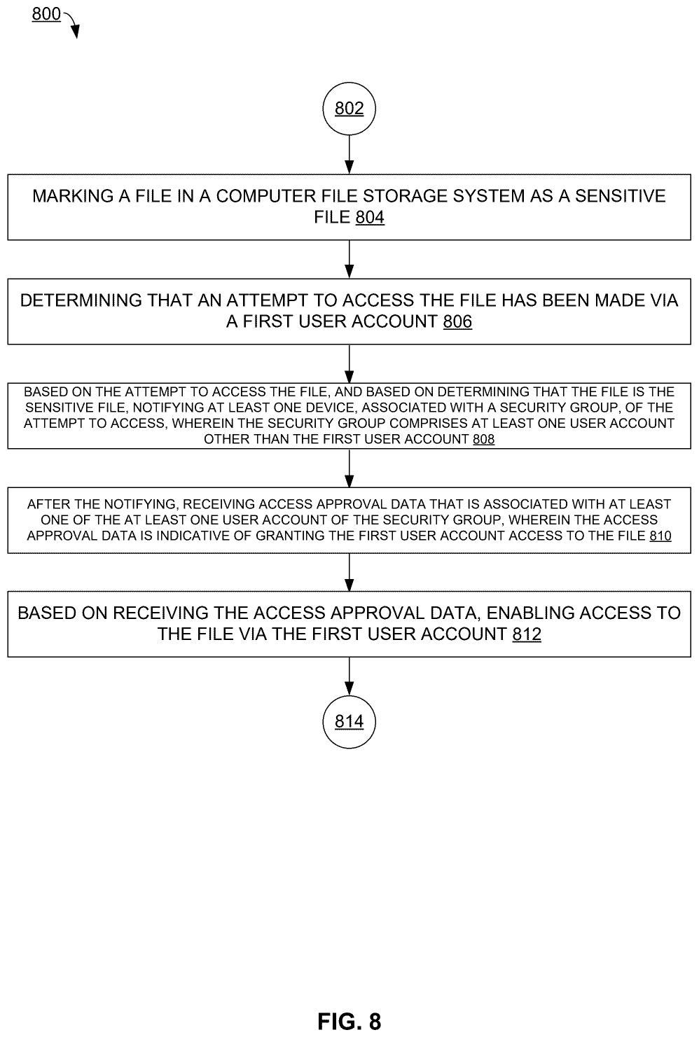

In some examples, multiple custody authorization component 108 can implement part(s) of the process flows of FIGS. 8-10 to facilitate multiple custody authorization.

It can be appreciated that system architecture 100 is one example system architecture for multiple custody authorization, and that there can be other system architectures that facilitate multiple custody authorization.

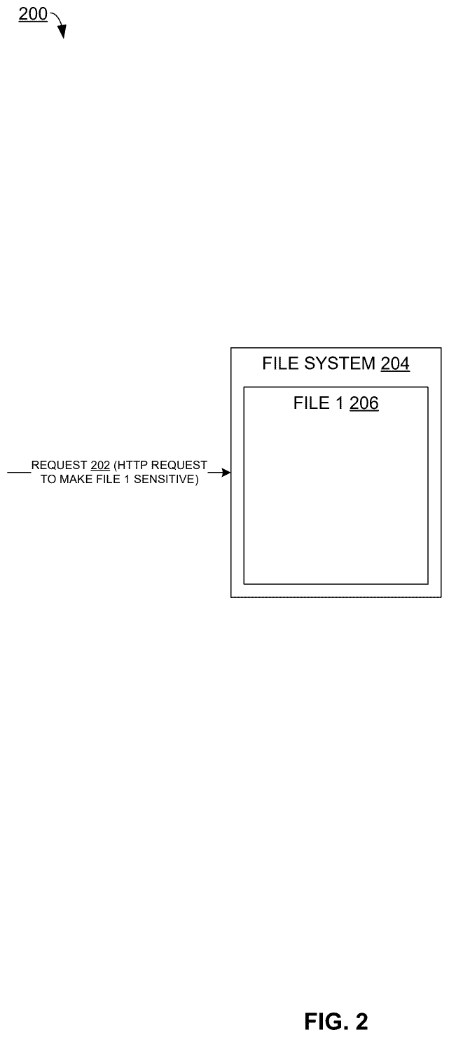

FIG. 2 illustrates part of an example 200 of a first file access attempt, and that can facilitate multiple custody authorization, in accordance with an embodiment of this disclosure. In some examples, part(s) of example 200 can be implemented by part(s) of system architecture 100 of FIG. 1 to facilitate multiple custody authorization.

FIGS. 2-4 can be considered together as part of one first file access attempt.

Example 200 comprises request 202 (hypertext transfer protocol (HTTP) request to make file 1 sensitive), file system 204, and file 1 206.

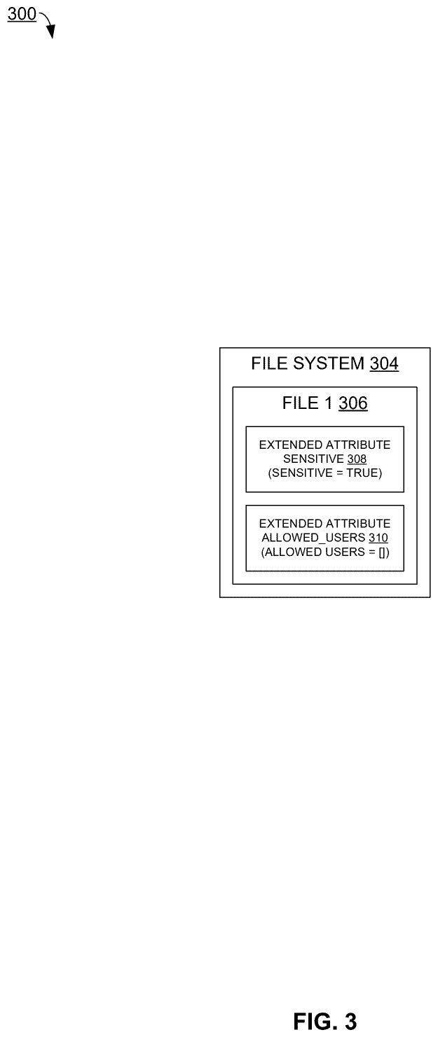

A result of processing request 202 can be illustrated in FIG. 3. At the point of example 200, file 1 206 is not deemed a sensitive file as described herein, and can be accessed by a user that has permission to access files that are not deemed sensitive (e.g., has RWX permissions in a UNIX file system).

FIG. 3 illustrates another part of an example 300 of the first file access attempt, and that can facilitate multiple custody authorization, in accordance with an embodiment of this disclosure. In some examples, part(s) of example 300 can be implemented by part(s) of system architecture 100 of FIG. 1 to facilitate multiple custody authorization.

Example 300 comprises file system 304, file 1 306, extended attribute sensitive 308, and extended attribute allowed_users 310.

In example 300, and as a result of request 202 of FIG. 2, two metadatas have been created for file 1 306. These are extended attribute sensitive 308, and extended attribute allowed_users 310. Extended attribute sensitive 308 indicates (via “sensitive=TRUE”) that this is a sensitive file that is subject to security group approval for access, and extended attribute allowed_users 310 indicates those users for whom security group approval has been made (here, the empty set “[ ]” indicates that no users are currently approved).

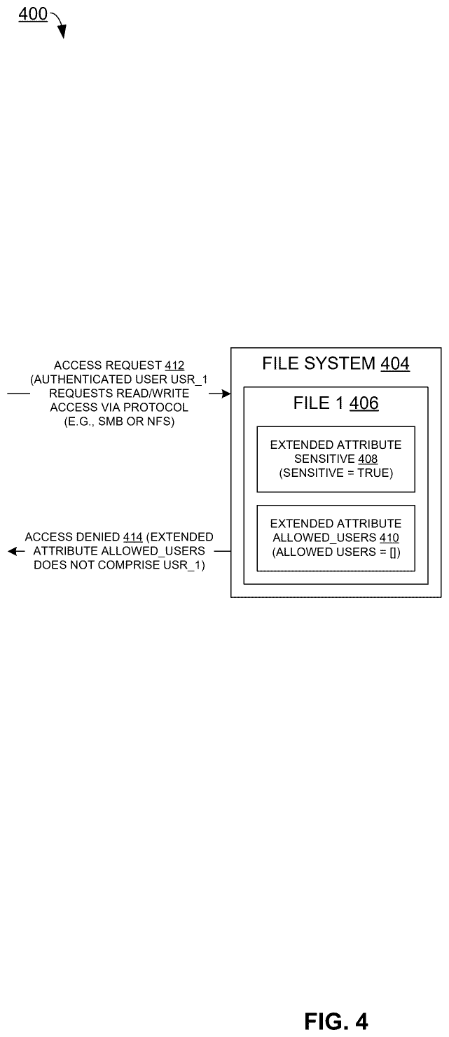

FIG. 4 illustrates another part of an example 400 of the first file access attempt, and that can facilitate multiple custody authorization, in accordance with an embodiment of this disclosure. In some examples, part(s) of example 400 can be implemented by part(s) of system architecture 100 of FIG. 1 to facilitate multiple custody authorization.

Example 400 comprises file 1 406, extended attribute sensitive 408, extended attribute allowed_users 410, access request 412 (authenticated user usr_1 requests read/write access via protocol (e.g., server message block (SMB) or network file system (NFS) protocols), and access denied 414 (extended attribute allowed_users does not comprise usr_1).

In example 400, usr_1 attempts to access file 1 406 via access request 412. Since “sensitive=TRUE” is set for extended attribute sensitive 308, a check of whether usr_1 is identified in extended attribute allowed_users 410. usr_1 is not identified in extended attribute allowed_users 410, so access to the file is denied, and access denied 414 is returned in response to access request 412.

In some examples, this “sensitive file” check can be made after determining that the user otherwise has permissions to access the file (e.g., has RWX permissions in a UNIX file system).

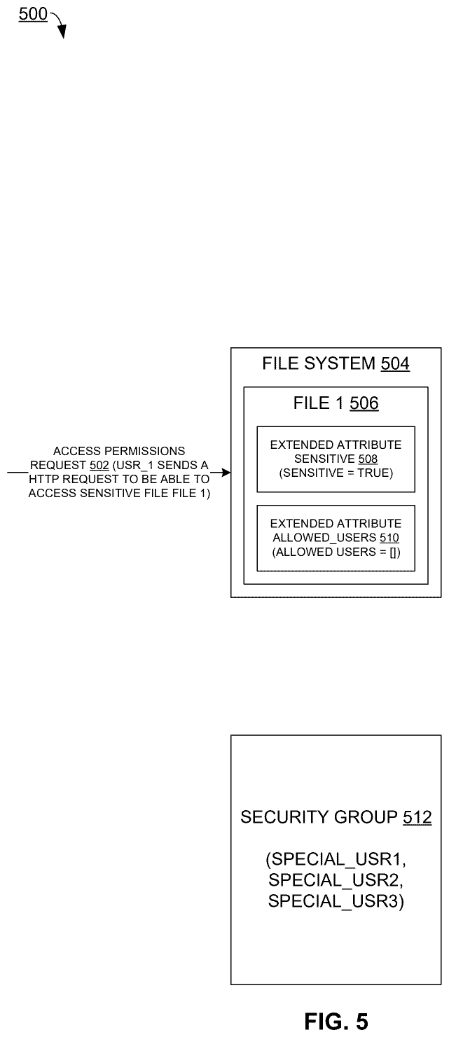

FIG. 5 illustrates part of an example 500 of a second file access attempt, and that can facilitate multiple custody authorization, in accordance with an embodiment of this disclosure. In some examples, part(s) of example 500 can be implemented by part(s) of system architecture 100 of FIG. 1 to facilitate multiple custody authorization.

FIGS. 5-7 can be considered together as part of one first file access attempt. In conjunction with the first file access attempt of FIGS. 2-4, FIG. 5 can occur at a point after example 300 of FIG. 3, where metadata for a file has been established to indicate that the file is sensitive.

Example 500 comprises access permissions request 502 (usr_1 sends a HTTP request to be able to access sensitive file file 1), file system 504, file 1 506, extended attribute sensitive 508, extended attribute allowed_users 510, and security group 512.

Rather than being a request to access the file itself, access permissions request 502 can comprise a request for permissions (from security group 512) to access the file at a later point in time.

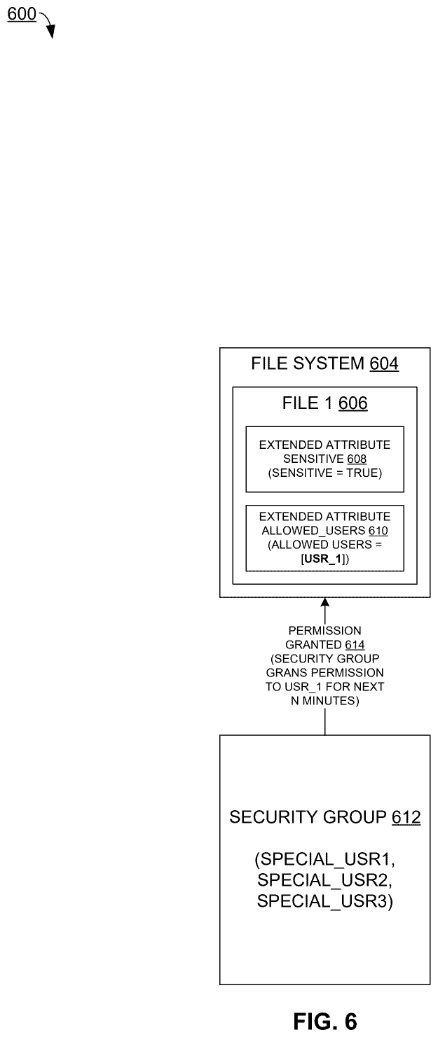

FIG. 6 illustrates another part of an example 600 of the second file access attempt, and that can facilitate multiple custody authorization, in accordance with an embodiment of this disclosure. In some examples, part(s) of example 600 can be implemented by part(s) of system architecture 100 of FIG. 1 to facilitate multiple custody authorization.

Example 600 comprises file system 604, file 1 606, extended attribute sensitive 608, extended attribute allowed_users 610, security group 612, and permission granted 614 (security group grans permission to usr_1 for next N minutes).

In example 600, access permissions request 502 has been processed by security group 612, and granted (conveyed by permission granted 614). As a result of the permission being granted, extended attribute allowed_users 610 is updated to include usr_1.

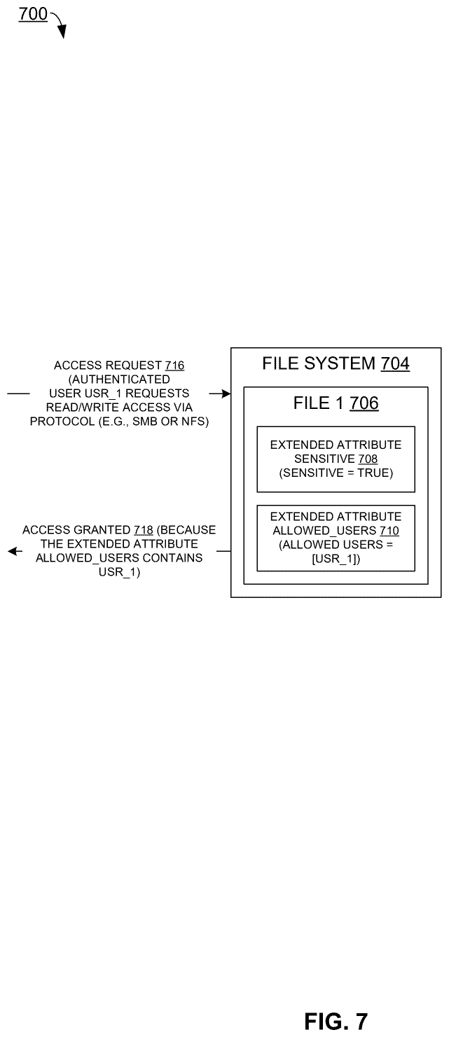

FIG. 7 illustrates another part of an example 700 of the second file access attempt, and that can facilitate multiple custody authorization, in accordance with an embodiment of this disclosure. In some examples, part(s) of example 700 can be implemented by part(s) of system architecture 100 of FIG. 1 to facilitate multiple custody authorization.

Example 700 comprises file system 704, file 1 706, extended attribute sensitive 708, extended attribute allowed_users 710, access request 716 (authenticated user usr_1 requests read/write access via protocol (e.g., SMB or NFS protocols), and access granted 718 (because the extended attribute allowed_users contains usr_1).

In example 700, permission granted 614 of example 600 has occurred. So, when access request 716 is made by usr_1 it is then granted in access granted 718.

Access granted 718 can comprise access being granted to then access file 1 706 rather than actually accessing file 1 706. In some examples, usr_1 can then access file 1 706 for a period of time when access to file 1 706 is allowed.

### Example Process Flows

FIG. 8 illustrates an example process flow 800 that can facilitate multiple custody authorization, in accordance with an embodiment of this disclosure. In some examples, one or more embodiments of process flow 800 can be implemented by system architecture 100 of FIG. 1, or computing environment 1100 of FIG. 11.

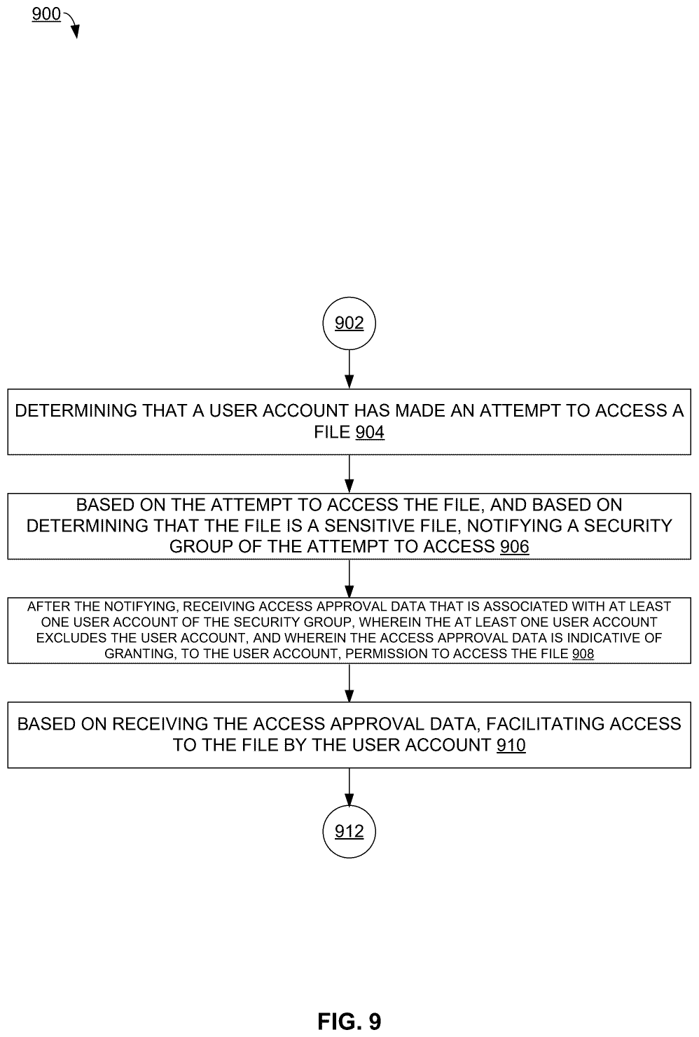

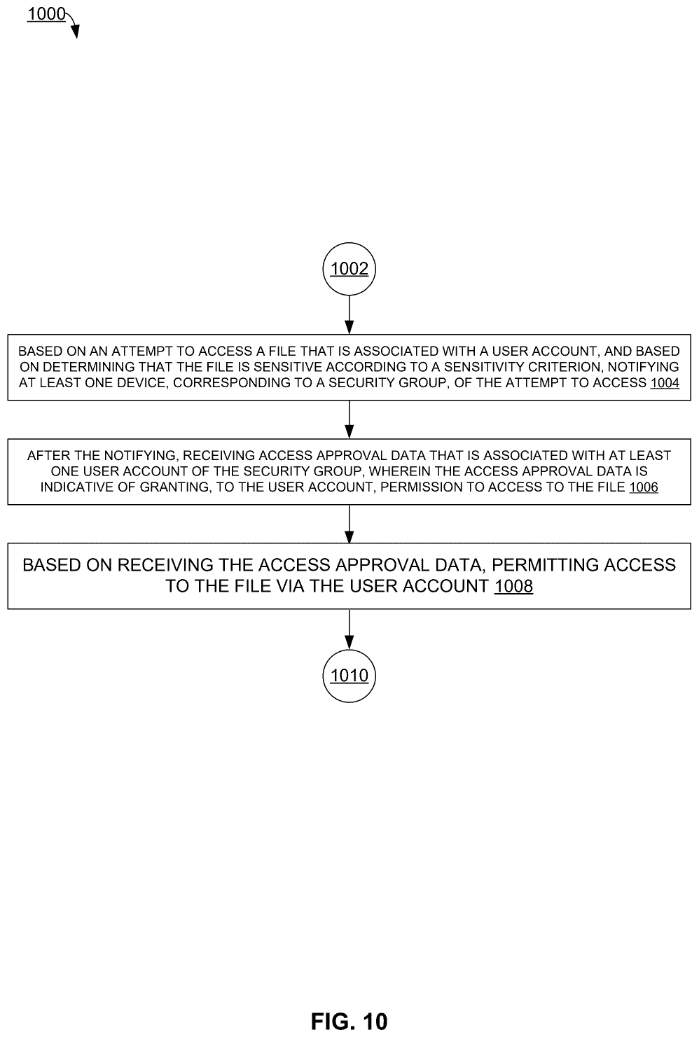

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of process flow 900 of FIG. 9, and/or process flow 1000 of FIG. 10.

Process flow 800 begins with 802, and moves to operation 804.

Operation 804 depicts marking a file in a computer file storage system as a sensitive file. This can be similar to that which is depicted in FIGS. 2-3.

In some examples, the marking of the file as the sensitive file comprises associating the file with first metadata that comprises a first indication that the file is the sensitive file, and associating the file with second metadata that comprises a second indication of user accounts permitted to access the file. This can be similar to extended attribute sensitive 508 and extended attribute allowed_users 510 of FIG. 5.

In some examples, the first metadata comprises a Boolean value. That is, extended attribute sensitive 508 of FIG. 5 can be set to TRUE or FALSE.

In some examples, the first metadata comprises a first extended attribute of the file, and wherein the second metadata comprises a second extended attribute of the file. That is, the metadata can be expressed in multiple extended attributes.

After operation 804, process flow 800 moves to operation 806.

Operation 806 depicts determining that an attempt to access the file has been made via a first user account. This can be similar to access permissions request 502 of FIG. 5.

After operation 806, process flow 800 moves to operation 808.

Operation 808 depicts, based on the attempt to access the file, and based on determining that the file is the sensitive file, notifying at least one device, associated with a security group, of the attempt to access, wherein the security group comprises at least one user account other than the first user account. This can be similar to a notification of security group 612 of FIG. 6 that is associated with the corresponding permission granted 614.

After operation 808, process flow 800 moves to operation 810.

Operation 810 depicts, after the notifying, receiving access approval data that is associated with at least one of the at least one user account of the security group, wherein the access approval data is indicative of granting the first user account access to the file. This can be similar to permission granted 614 of FIG. 6.

In some examples, the access approval data indicates an amount of time for which access to the file via the first user account is approved, and wherein the enabling of the access to the file via the first user account is performed for the amount of time. That is, access can be granted for a finite amount of time.

In some examples, the access approval data indicates an amount of time for which access to the file via the first user account is approved, and operation 810 comprises removing an indication of the first user account from metadata for the file after the amount of time has elapsed, wherein the indication of the first user account indicates that the first user account has been authorized to access the file based on information received from the at least one device associated with the security group. That is, where granting access for a user is performed for a set amount of time, and comprises adding the user name to allowed_users, the user name can be removed from allowed_users when that amount of time has elapsed.

After operation 810, process flow 800 moves to operation 812.

Operation 812 depicts, based on receiving the access approval data, enabling access to the file via the first user account. This can be similar to access granted 714 of FIG. 7.

In some examples, the enabling of the access to the file comprises determining that the first metadata indicates that the file is the sensitive file, determining that the first user account is represented in the second metadata. That is, using the example of FIG. 5, that this can comprise determining that extended attribute sensitive 508 is set to TRUE, and that extended attribute allowed_users 510 identifies the user account.

In some examples the file is a first file, and operation 812 comprises, based on determining that a second file omits third metadata that indicates that the second file is the sensitive file, authorizing access the second file via a third user account based on credentials associated with the third user account, wherein the third user account comprises the first user account or another user account other than the first user account or the at least one user account. That is, where a file is not marked as sensitive, file access can be authorized based on the requestor's credentials (and not whether the requestor is identified in allowed_users).

After operation 812, process flow 800 moves to 814, where process flow 800 ends.

FIG. 9 illustrates another example process flow 900 that can facilitate multiple custody authorization, in accordance with an embodiment of this disclosure. In some examples, one or more embodiments of process flow 900 can be implemented by system architecture 100 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of process flow 800 of FIG. 8, and/or process flow 1000 of FIG. 10.

Process flow 900 begins with 902, and moves to operation 904.

Operation 904 depicts determining that a user account has made an attempt to access a file. In some examples, operation 904 can be implemented in a similar manner as operation 806 of FIG. 8.

In some examples, the determining that the user account has made the attempt to access the file comprises receiving user input data at a user interface that is indicative of the attempt to access the file, wherein the user input data is associated with the user account. This can comprise receiving user input indicative of a user's interest in accessing a sensitive file at user interface component 118 of FIG. 1

After operation 904, process flow 900 moves to operation 906.

Operation 906 depicts, based on the attempt to access the file, and based on determining that the file is a sensitive file, notifying a security group of the attempt to access. In some examples, operation 906 can be implemented in a similar manner as operation 808 of FIG. 8.

In some examples, the notifying of the security group of the attempt to access comprises sending respective notifications to respective user accounts that are members of the security group. That is, a security group can comprise multiple members, who can each receive notification of an access request.

After operation 906, process flow 900 moves to operation 908.

Operation 908 depicts, after the notifying, receiving access approval data that is associated with at least one user account of the security group, wherein the at least one user account excludes the user account, and wherein the access approval data is indicative of granting, to the user account, permission to access the file. In some examples, operation 908 can be implemented in a similar manner as operation 810 of FIG. 8.

After operation 908, process flow 900 moves to operation 910.

Operation 910 depicts, based on receiving the access approval data, facilitating access to the file by the user account. In some examples, operation 910 can be implemented in a similar manner as operation 812 of FIG. 8.

In some examples, the facilitating of the access to the file to the user account comprises adding an indication of the user account to a metadata of the file, wherein the metadata indicates user accounts that are approved to access the file. That is, a user name (or other identifier) can be added to an allowed_users extended attribute once a security group member gives consent for the access.

In some examples, the facilitating of the access to the file to the user account comprises making a notification of approval to access the file available to the user account. That is, a user account can be notified that it has been granted access to the file.

in some examples, the facilitating of the access to the file to the user account comprises determining that a credential associated with the user account is valid regarding accessing the file, wherein the credential is separate from the access approval data. That is, access granted by a security group can be in addition to access validation using the user's credentials, like with a non-sensitive file.

After operation 910, process flow 900 moves to 912, where process flow 900 ends.

FIG. 10 illustrates another example process flow 1000 that can facilitate multiple custody authorization, in accordance with an embodiment of this disclosure. In some examples, one or more embodiments of process flow 1000 can be implemented by system architecture 100 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of process flow 800 of FIG. 8, and/or process flow 900 of FIG. 9.

Process flow 1000 begins with 1002, and moves to operation 1004.

Operation 1004 depicts, based on an attempt to access a file that is associated with a user account, and based on determining that the file is sensitive according to a sensitivity criterion, notifying at least one device, corresponding to a security group, of the attempt to access. In some examples, operation 1004 can be implemented in a similar manner as operations 804-808 of FIG. 8.

In some examples, the marking of the file in as the sensitive file is performed via a call of an application programming interface. In some examples, the application programming interface comprises a representational state transfer application programming interface. That is, there can be a REST API exposed by which calls to set files to be sensitive can be made.

After operation 1004, process flow 1000 moves to operation 1006.

Operation 1006 depicts, after the notifying, receiving access approval data that is associated with at least one user account of the security group, wherein the access approval data is indicative of granting, to the user account, permission to access to the file. In some examples, operation 1006 can be implemented in a similar manner as operation 810 of FIG. 8.

In some examples, the access approval data indicates that each user account of the at least one user account of the security group approves of the granting. In some examples, the access approval data indicates that a number of user accounts of the at least one user account of the security group approves of the granting, wherein the number is determined to satisfy a threshold approval criterion, and wherein the number is greater than one. That is, there can be examples where unanimous access approval by the security group is required, or that there is a certain level of quorum by the security group required (e.g., more than one security group member, but less than unanimous consent).

After operation 1006, process flow 1000 moves to operation 1008.

Operation 1008 depicts, based on receiving the access approval data, permitting access to the file via the user account. In some examples, operation 1008 can be implemented in a similar manner as operation 812 FIG. 8.

In some examples, the user account is a first user account, and operation 1008 comprises denying access to the file to a second user account independently of whether the second user account is approved by the security group to access the file, wherein the second user account lacks credentials for access of the file. That is, regardless of security group approval, it can be that a user still needs to provide credentials to access a file.

After operation 1008, process flow 1000 moves to 1010, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of computer system 102 and/or user computer 106 of FIG. 1.

In some examples, computing environment 1100 can implement one or more embodiments of the process flows of FIGS. 8-10 to facilitate multiple custody authorization.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1116 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
marking a file in a computer file storage system as a sensitive file;
determining that an attempt to access the file has been made via a first user account;
based on the attempt to access the file, and based on determining that the file is the sensitive file, notifying at least one device, associated with a security group, of the attempt to access, wherein the security group comprises at least one user account other than the first user account;
after the notifying, receiving access approval data that is associated with at least one of the at least one user account of the security group, wherein the access approval data is indicative of granting the first user account access to the file; and
based on receiving the access approval data, enabling access to the file via the first user account.

2. The system of claim 1, wherein the marking of the file as the sensitive file comprises:
associating the file with first metadata that comprises a first indication that the file is the sensitive file; and
associating the file with second metadata that comprises a second indication of user accounts permitted to access the file.

3. The system of claim 2, wherein the first metadata comprises a Boolean value.

4. The system of claim 2, wherein the enabling of the access to the file comprises:
determining that the first metadata indicates that the file is the sensitive file; and
determining that the first user account is represented in the second metadata.

5. The system of claim 2, wherein the first metadata comprises a first extended attribute of the file, and wherein the second metadata comprises a second extended attribute of the file.

6. The system of claim 2, wherein the file is a first file, and wherein the operations further comprise:
based on determining that a second file omits third metadata that indicates that the second file is the sensitive file, authorizing access the second file via a third user account based on credentials associated with the third user account, wherein the third user account comprises the first user account or another user account other than the first user account or the at least one user account.

7. The system of claim 1, wherein the access approval data indicates an amount of time for which access to the file via the first user account is approved, and wherein the enabling of the access to the file via the first user account is performed for the amount of time.

8. The system of claim 1, wherein the access approval data indicates an amount of time for which access to the file via the first user account is approved, and wherein the operations further comprise:
removing an indication of the first user account from metadata for the file after the amount of time has elapsed, wherein the indication of the first user account indicates that the first user account has been authorized to access the file based on information received from the at least one device associated with the security group.

9. A method, comprising:
determining, by a system comprising at least one processor, that a user account has made an attempt to access a file;
based on the attempt to access the file, and based on determining that the file is a sensitive file, notifying, by the system, a security group of the attempt to access;
after the notifying, receiving, by the system, access approval data that is associated with at least one user account of the security group, wherein the at least one user account excludes the user account, and wherein the access approval data is indicative of granting, to the user account, permission to access the file; and
based on receiving the access approval data, facilitating, by the system, access to the file by the user account.

10. The method of claim 9, wherein the determining that the user account has made the attempt to access the file comprises:
receiving user input data at a user interface that is indicative of the attempt to access the file, wherein the user input data is associated with the user account.

11. The method of claim 9, wherein the notifying of the security group of the attempt to access comprises:
sending respective notifications to respective user accounts that are members of the security group.

12. The method of claim 9, wherein the facilitating of the access to the file to the user account comprises:
adding an indication of the user account to a metadata of the file, wherein the metadata indicates user accounts that are approved to access the file.

13. The method of claim 9, wherein the facilitating of the access to the file to the user account comprises:
making a notification of approval to access the file available to the user account.

14. The method of claim 9, wherein the facilitating of the access to the file to the user account comprises:
determining that a credential associated with the user account is valid regarding accessing the file, wherein the credential is separate from the access approval data.

15. A non-transitory computer-readable medium comprising instructions that, in response to execution, cause a system comprising at least one processor to perform operations, comprising:
based on an attempt to access a file that is associated with a user account, and based on determining that the file is sensitive according to a sensitivity criterion, notifying at least one device, corresponding to a security group, of the attempt to access;
after the notifying, receiving access approval data that is associated with at least one user account of the security group, wherein the access approval data is indicative of granting, to the user account, permission to access to the file; and
based on receiving the access approval data, permitting access to the file via the user account.

16. The non-transitory computer-readable medium of claim 15, wherein the access approval data indicates that each user account of the at least one user account of the security group approves of the granting.

17. The non-transitory computer-readable medium of claim 15, wherein the access approval data indicates that a number of user accounts of the at least one user account of the security group approves of the granting, wherein the number is determined to satisfy a threshold approval criterion, and wherein the number is greater than one.

18. The non-transitory computer-readable medium of claim 15, wherein the user account is a first user account, and wherein the operations further comprise:
denying access to the file to a second user account independently of whether the second user account is approved by the security group to access the file, wherein the second user account lacks credentials for access of the file.

19. The non-transitory computer-readable medium of claim 15, wherein the marking of the file in as the sensitive file is performed via a call of an application programming interface.

20. The non-transitory computer-readable medium of claim 19, wherein the application programming interface comprises a representational state transfer application programming interface.
